(19) United States
(12) Patent Application Publication
(10) Pub. No.: US 2022/0051550 A1
(43) Pub. Date: Feb. 17, 2022

(54) SELF-DEFENSE AND ALERT SYSTEM

(71) Applicant: Eyal Aaron Gavshon, (US)

(72) Inventor: Eyal Aaron Gavshon, Irvine, CA (US)

(21) Appl. No.: 16/990,762

(22) Filed: Aug. 11, 2020

(51) Int. Cl. G08B 25/01; G08B 25/12; G08B 15/02; G08B 15/00; H04W 4/029; H04W 4/90

(52) U.S. Cl. CPC G08B 25/016; G08B 25/12; H04W 4/90; G08B 15/004; H04W 4/029; G08B 15/02

(57) ABSTRACT

Self-defense devices, methods, and computer program products such as a pepper spray may take one or more photographs of the assailant and send the photos and/or other data (e.g., time, location) to an emergency responder with the location. The self-defense device may also send a message to the user's emergency contacts alerting the contacts that their contact has used the self-defense device and may include the location of where the self-defense device was activated and other information about the situation and/or user.

### FIELD OF USE

The present application generally relates to a self-defense system, and more particularly to a self-defense system that upon activation performs an alert.

### DESCRIPTION OF RELATED ART

Various types of pepper spray are used in policing, riot control, and self-defense. In self-defense contexts, pepper spray is used against both human and animal targets such as dogs and bears to allow a user to subdue or flee from the threat. Defense products, however, can help deter or defend against an attacker but do not aid in the identification or arrest of the attacker or to provide further aid to the user. Identification may be especially difficult after a traumatic incident for the victim to describe the attacker or remember the precise location of the incident.

### BRIEF DESCRIPTION OF THE FIGURES

FIG. 1 is a diagram illustrating a system for self-defense and alert according to an embodiment of the present disclosure.

FIG. 2A is a diagram illustrating an external view of a self-defense and alert device according to an embodiment of the present disclosure.

FIG. 2B is a diagram illustrating an internal view of a self-defense and alert device according to an embodiment of the present disclosure.

FIG. 3 is a flow chart showing a method for using a self-defense and alert device according to an embodiment of the present disclosure.

### DETAILED DESCRIPTION

Self-defense devices such as pepper sprays, stun guns, air horns or whistles, and firearms may help to deter an attacker but fail to help in the identification and capture of the perpetrator. Identification is especially difficult after a traumatic incident for the victim to describe the attacker or other specifics of the attack. According to embodiments of the present disclosure, a self-defense device such as a pepper spray may take one or more photographs of the assailant and send the photos and/or other data (e.g., time, location) to the police with the location. The self-defense device may also send a message to the user's emergency contacts alerting the contacts that their contact has used the self-defense device and may include the location of where the self-defense device was activated and other information about the situation and/or user.

The self-defense device may connect with one or more emergency responder (e.g., police, emergency dispatch/“9-1-1”) server to transmit the data (e.g., images, location data) rather than storing the images on an intermediate server. However, in another embodiment, the self-defense device may transmit the data to another user device (e.g., cellular phone, smart watch) which may send the data to an emergency responder server. In another embodiment, the self-defense device (either directly or through another user device) may transmit the data to an intermediary server for storage and/or to direct the data to the emergency responder servers and/or emergency contacts of the user.

As described herein, the described techniques may apply to self-defense devices and may also apply to body cameras, mobility devices (cars, bicycles, motorcycles, trucks, planes, scooters), and/or toys.

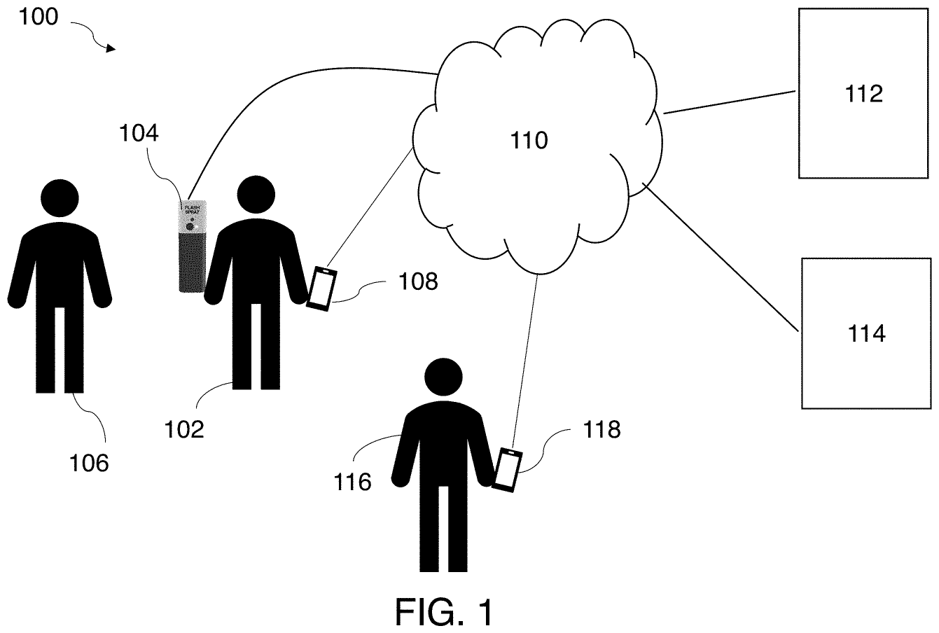

FIG. 1 illustrates a block diagram of a self-defense and alert system 100. User 102 may wish to activate self-defense device 104 against assailant 106. Self-defense device 104 may be connected to user device 108 via network 110. Network 110 connects self-defense device 104 and user device 108 to emergency response server 112, storage and direction server 114, and/or emergency contact 116 or emergency contact device 118.

Self-defense device 104 may include any type of personal protection equipment such as pepper (capsaicin) or mace sprays, stun guns (or conducted electrical weapons such as TASER), air horns or whistles, and/or firearms or related equipment such as body cameras or mobility devices. Self-defense device 104 may help to deter and aid in the identification and capture of assailant 106. In an exemplary scenario, assailant 106 may threaten, attack, or injure user 102. User 102 may activate self-defense device 104 by pressing a button on self-defense device 104, pulling a trigger on self-defense device 104, using voice activation, through a gesture command, via a command from another device (such as from user device 108), or through facial or voice recognition of assailant 106. Self-defense device 104 may simultaneously discharge/fire a payload (e.g., a pepper spray, one or more barbed darts, a bullet or other projectile) at assailant 106 or another target and captures one or more images or videos. Additional data that may be captured at the time of firing the payload include timestamp information, location information (latitude/longitude coordinates, city or neighborhood data, ZIP code), and/or audio recording. Self-defense device 104 may flash light at assailant 106 to illuminate assailant 106 for improved picture quality and/or to temporarily blind or visually impair assailant 106. Self-defense device 104 may send this information (image information as well as one or more pieces of the additional data) for external storage in user device 108, emergency response server 112, and/or storage and direction server 114. An alert may be sent to emergency responders (e.g., police, emergency dispatchers) and emergency contacts 116 (e.g., friends and family) of user 102 through emergency contact device 118 that the self-defense device 104 was activated and may include one or more images/video and other captured data. In an embodiment, an alert is sent to devices (e.g. with an application associated with self-defense device 104) within a radius (e.g., 100 yards, 1 mile, 5 miles, 10 miles) of self-defense device 104 (from self-defense device 104, user device 108, emergency response server 112, or storage and direction server 114) using GPS coordinates of the receiving device.

Network 110 may include a single network or a combination of multiple networks. For example, in various embodiments, network 110 may include the Internet or one or more intranets, landline networks, wireless networks, and/or other appropriate types of networks. Wireless networks may include short range wireless communications (e.g., Bluetooth Low Energy (BLE), Bluetooth, near field communications (NFC), WiFi, LTE Direct, radio, infrared, etc.). Wireless networks also may include cellular networks and satellite networks.

User device 108 and emergency contact device 118 may include a personal computer (PC), a smart phone, personal digital assistant (PDA), laptop computer, and/or other types of computing devices capable of transmitting and/or receiving data, such as a tablet computer, wearable device such as a smart watch, or other personal electronic device. User device 108 may be configured to receive data from self-defense device 104. The data may include images or video, audio recording, location, and/or timestamp data. This data received from self-defense device 104 may be augmented by user device 108 to add additional data such as location data, additional images or video, captured audio, timestamp, and/or emergency contacts. Some or all of the augmented data may be sent to emergency response server 112 and/or storage and direction server 114 to alert emergency responders and the emergency contacts of user 102, via network 110. User device 108 may be used to alert user contacts (e.g., emergency contact 116) using designated emergency information (with e.g., a phone number of emergency contact device 118) in user device 108. The emergency information may be from a contact list of user 102 or identified emergency contact information in user device 108. Emergency information may include a phone number, an Internet Protocol (IP) address, an email address, or a username for a messaging or alert service.

Additionally, user device 108 may alert a user to stay in visible areas and alert a user with information about crime statistics in the area they are located. These alerts may be time based and may occur after sunset/dusk or before sunrise/dawn. A map interface may be displayed on user device 108 identifying recent criminal activity. Data may be received from storage and direction server 114, via network 110. User device 108 may receive the alert information from storage and/or and direction server 114 or from emergency response server 112. The alerts may include a notification or popup on user device 108. Alerts may also include a visual (e.g., a light), auditory (e.g., a sound, tone, or chime), or haptic (e.g., vibration) alert on user device 108 or on self-defense device 104.

Storage and direction server 114 may be configured to receive data from self-defense device 104 upon activation/user. Storage and direction server 114 may receive the data via network 110 from self-defense device 104 user device 108. Storage and direction server 114 may store data received from self-defense device 104 user device 108. Storage and direction server 114 may send stored data to the applicable emergency response server 112 based on the location of user 102/user device 108/self-defense device 104 the timing of the activation, and an address and user location mapping table.

Emergency response server 112 may be configured to receive data (image data, location data, timestamp information, etc.) from self-defense device 104 (via user device 108, storage and direction server 114, and/or network 110). Emergency response server 112 may send an alert and received data to emergency dispatchers and/or emergency responders (e.g. police) to respond to an emergency at the received location. Assailant 106 may be identified by the captured images/video. The identification of assailant 106 may be via facial/audio recognition on the captured images/video/audio.

Emergency contact device 118 may receive an alert from self-defense device 104, user device 108, or storage and direction server 114 via network 110 for use by emergency contact 116. The alert may contain information about the location of user 102/user device 108/self-defense device 104, the timing of the activation, captured data such as image/video/audio data, and an address and/or user location mapping table.

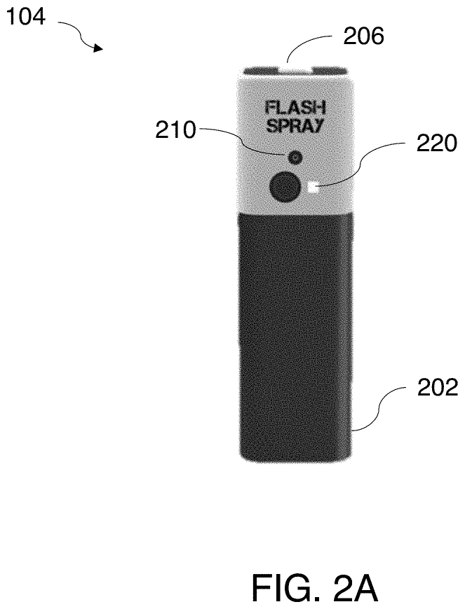

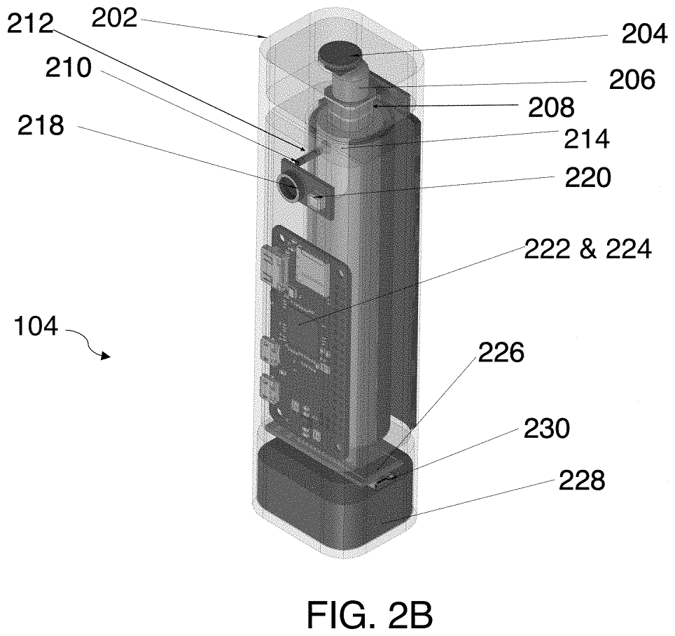

FIG. 2A is a diagram illustrating an external view of self-defense device 104 according to an embodiment of the present disclosure. FIG. 2B is a diagram illustrating an internal view of self-defense device 104 according to an embodiment of the present disclosure. Self-defense device 104 may include housing 202, safety button 204, button 206, limit switch 208, nozzle 210, clip tube 212, reservoir 214, pepper spray, camera 218, flash 220, processor 222, memory 224, networking module 226, battery 228, and charging port 230.

Housing 202 may contain and protect internal components of self-defense device 104. Housing 202. Housing 202 may be shaped to be held in the hand of user 102 and include a textured or hand molded grip area to reduce hand slipping. Housing 202 may include cutouts for buttons (e.g., safety button 204 and button 206), nozzle 210, camera 218, flash 220, a speaker, a microphone, indicator lights/display, and charging port 230. In some embodiments, housing 202 may include a hole for a string and keyring attachable to a keychain. In some embodiments, housing 202 may include a bezel/tactical spikes on a side of housing 202 usable to inflict blunt force trauma when struck against assailant 106. In other embodiments, housing 202 may accept a replaceable canister including reservoir 214 and pepper spray which is connectable to processor 222 via sensor input.

Safety button 204 may include a mechanism to unlock button 206 to enable self-defense device 104 to discharge. When deactivated, button 206 will be unable to be triggered or discharged. This safety feature of self-defense device 104 may prevent accidental discharge. In some embodiments, safety button 204 may include a twist lock or a switch. In other embodiments, safety button 204 may include or be in communication with a fingerprint scanner for added security and protection.

Button 206 may include a plunging mechanism that triggers discharge of pepper spray (or other payload, projectile, liquid, etc.) through nozzle 210. In some examples, button 206 is spring loaded. Button 206 may activate alert and safety mechanisms such as camera 218, flash 220, network communication to alert authorities or emergency contacts about the activation of the self-defense device 104 by triggering limit switch 208. Pressing button 206 may trigger a sensor which sends a message to processor 222 indicating button 206 was pressed. In alternative embodiments, button 206 may include a trigger. Button 206 may also be triggered via an audio command or via another device of user 102, e.g., user device 108.

Limit switch 208 may include a sensor to determine when button 206 is depressed or when pepper spray is released through nozzle 210. Limit switch 208 may send an signal to processor 222 to wake from a low power state, to activate camera 218, to capture location information, and to send captured and collected data to one or more devices (e.g., user device 108), emergency contacts, emergency services, and safe locations.

Nozzle 210 is configured to emit the pepper or other spray from reservoir 214 through dip tube 212 within housing 202. In some embodiments, nozzle 210 is an atomizer. Nozzle 210 may release a pepper spray when triggered by button 206. The spray released may be formed by a mesh opening or aperture to release a burst, stream, foam, or mist of pepper spray from reservoir 214 through nozzle 210.

In an embodiment, reservoir 214 is under pressure, and upon a user press of button 206 a valve is released opening the sealed and pressurized reservoir 214 releasing the pepper spray (and, in some examples, a propellant) from within reservoir 214 through a dip tube 212 and out nozzle 210.

Pepper spray may include a lachrymatory agent which may include one or a combination of chemicals such as capsaicin. In example embodiments, pepper spray includes one or more of CS (Orthochlorobenzalmalononitrile), CN (Alphachloroacetaphenone) and OC (Oleoresin Capsicum), however various types of chemicals may be used consistent with the present disclosure. Pepper spray is designed to irritate the eyes and of assailant 106 and may cause a burning sensation, pain, and/or (temporary) blindness when applied to the eyes. In some examples, pepper spray includes a marked dye (of either ultra violet (UV) or colored dye/ink) or an odor (e.g., skunk odor) to repel and/or identify assailant 106 after coming in contact with pepper spray.

In some embodiments, self-defense device 104 may include a speaker to play a loud audible tone as a primary or additional defense mechanism. In some examples, the loud audible tone is directional to direct sound energy toward assailant 106.

Camera 218 may include a shutter and lens and is connected to the flash. Camera 218 and flash 220 may be controlled by processor 222 and images captured by camera 218 may be stored in memory 224. Images may be captured by camera 218 in response to pressing of button 206. Images captured by camera 218 may be transmitted via networking module 226 to other devices via network 110. In some embodiments, flash 220 may be configured to strobe for a period of time (e.g., 5 seconds, 10 seconds) in response to receiving a signal that button 206 was pressed. In some embodiments, self-defense device 104 may include a microphone to capture audio. Self-defense device 104 may combine data from camera 218 (e.g., video) with captured audio.

Self-defense device 104 may include Indicator lights to alert user 102 the power is on, the status of battery 228, the network connection status or the network connection with user device 108, and/or an indication that data is transmitting.

Processor 222 may include one or more digital signal processors (DSPs), general purpose microprocessors, application specific integrated circuits (ASICs), field programmable logic arrays (FPGAs), or other equivalent integrated or discrete logic circuitry. Processor 222 may be the CPU of self-defense device 104. Processor 222 may be one component on a system on chip (SoC). In some examples, processor 222 may include a single board computer such as the RASPBERRY PI. Memory 224 may store instructions for execution of the one or more applications. The execution of an application on processor 222 causes processor 222 to produce alert data which may include descriptive data (time, location), captured media data (photographs, video, audio) as well as contact data of other devices (e.g., Internet Protocol (IP) addresses, phone numbers).

Networking module 226 may include an antenna to connect wirelessly to one or more networks. Networking module 226 may be configured to establish and send/receive data via one or more networks including short range wireless communications (e.g., Bluetooth Low Energy (BLE), Bluetooth, near field communications (NFC), WiFi, LTE Direct, radio, infrared, etc.), and may include cellular networks and satellite networks.

Global Positioning System (GPS) module may be configured to determine location coordinates from one or more GPS satellite signals.

Battery 228 may power electronic components of self-defense device 104 including processor 222, memory 224, and networking module 226. Battery 228 may be charged using charging port 230.

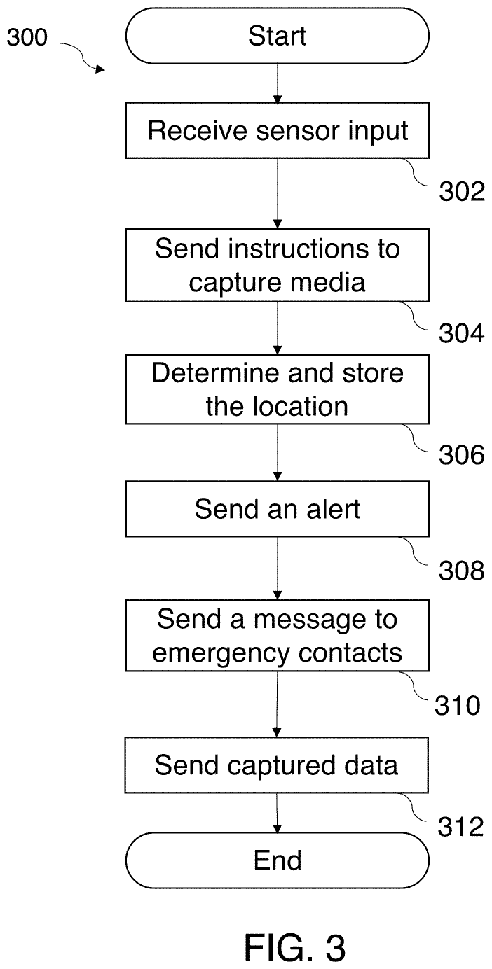

FIG. 3 is flowchart 300 illustrating an example method of operating a self-defense device according to the techniques of this disclosure. The techniques of FIG. 3 may be implemented by processor 222.

Processor 222 may receive a signal from limit switch 208 indicating that button 206 was pressed, at block 302. Button 206 may also be pushed, depressed, or triggered. In an exemplary embodiment, a daemon process executing on processor 222 may receive input from limit switch 208. In response, processor 222 may send instructions to capture one or more images (e.g., three images), video, audio to camera 218 and/or flash 220, at block 304. In an exemplary embodiment, the daemon process executes one or more processes to capture media (e.g., one or a burst of photographs, video, audio). Processor 222 may determine and store the location (using, e.g., GPS) of self-defense device 104, at block 306.

Processor 222 may send an alert which may include captured data (e.g., media and/or location data) to other devices, at block 308. In one example, captured data is sent to a personal device of the user, e.g., user device 108. The captured data may be sent to an application on user device 108 which may then relay the data to emergency response server 112, storage and direction server 114, and/or emergency contact device 118. In some embodiments, the application is associated with self-defense device 104. In another example, captured data is sent to storage and direction server 114 before being forwarded to emergency response server 112 and/or emergency contacts (including, e.g., emergency contact device 118). In another example, processor 222 may send captured data to one or more of emergency response server 112, storage and direction server 114, and/or emergency contact device 118 without sending data to user device 108 or storage and direction server 114.

At block 310, processor 222 may send a message to emergency contacts, at block 310. In some examples, emergency contacts are retrieved by self-defense device 104 during device setup (prior to receiving the signal from limit switch 208) by querying the user or synching contacts with user device 108. In another example, self-defense device 104 may send an alert (with captured data) to user device 108 that contacts emergency contacts. Processor 222 may send a message via an application programming interface (API) to a connectivity service, e.g., TWILIO, to send an email, Short Message Service (SMS)/text message, and/or voice message to emergency contacts of user 102.

Processor 222 may send captured data to storage and direction server 114 for storage, at block 312. This may allow for retrieval of the captured data should self-defense device 104 be lost or destroyed.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a pepper spray, stun gun, wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims

What is claimed is:

1. A method of operating a self-defense device comprising:
receiving, by a processor on the self-defense device, sensor input that the self-defense device has been triggered;
capturing one or more photographs using a camera on the self-defense device;
determining a location of the self-defense device;
sending the one or more photographs and the location of the self-defense device to an emergency response server; and
sending the location of the self-defense device to one or more emergency contacts.

2. The method of claim 1, wherein sending the one or more photographs and the location to the emergency response server is performed without storage of the one or more photographs and the location on a server associated with the self-defense device.

3. The method of claim 1, wherein receiving sensor input that the self-defense device has been triggered comprises receiving sensor input that a user has pushed a button on the self-defense device releasing a pepper spray.

4. The method of claim 1, wherein the one or more photographs comprises a video.

5. The method of claim 1, further comprising sending the one or more photographs and the location of the self-defense device to a storage server.

6. The method of claim 1, further comprising: retrieving emergency contacts from a user device associated with a user of the self-defense device.

7. The method of claim 1, wherein the self-defense device comprises: a pepper spray, a stun gun, a firearm, or a body camera.

8. A self-defense device comprising:
a sensor;
a camera configured to capture one or more photographs;
a memory; and
a processor in communication with the memory and configured to:
receive sensor input from the sensor that the self-defense device has been triggered;
send instructions to the camera to capture one or more photographs;
determine a location of the self-defense device;
send at least one of the one or more photographs and the location of the self-defense device to an emergency response server; and
send the location of the self-defense device to one or more emergency contacts.

9. The self-defense device of claim 8, wherein sending the one or more photographs and the location to the emergency response server is performed without storage of the one or more photographs and the location on a server associated with the self-defense device.

10. The self-defense device of claim 8, wherein the self-defense device further comprises a button configured to release a pepper spray and receiving sensor input that the self-defense device has been triggered comprises receiving sensor input that a user has pushed the button on the self-defense device releasing the pepper spray.

11. The self-defense device of claim 8, wherein the one or more photographs comprises a video.

12. The self-defense device of claim 8, wherein the processor is further configured to send the one or more photographs and the location of the self-defense device to a storage server.

13. The self-defense device of claim 8, wherein the processor is further configured to retrieve emergency contacts from a user device associated with a user of the self-defense device.

14. The self-defense device of claim 8, wherein the self-defense device comprises: a pepper spray, a stun gun, a firearm, or a body camera.

15. A non-transitory computer-readable storage medium storing instructions that when executed by one or more processors cause the one or more processors to:
receive, on a self-defense device, sensor input that the self-defense device has been triggered;
capture one or more photographs using a camera on the self-defense device;
determine a location of the self-defense device;
send the one or more photographs and the location of the self-defense device to an emergency response server; and
send the location of the self-defense device to one or more emergency contacts.

16. The non-transitory computer-readable storage medium of claim 15, wherein the sending the one or more photographs and the location to the emergency response server is performed without storage of the one or more photographs and the location on a server associated with the self-defense device.

17. The non-transitory computer-readable storage medium of claim 15 wherein receiving sensor input that the self-defense device has been triggered comprises receiving sensor input that a user has pushed a button on the self-defense device releasing a pepper spray.

18. The non-transitory computer-readable storage medium of claim 15 wherein the one or more photographs comprises a video.

19. The non-transitory computer-readable storage medium of claim 15, wherein the instructions that when executed by the one or more processors further cause the one or more processors to send the one or more photographs and the location of the self-defense device to a storage server.

20. The non-transitory computer-readable storage medium of claim 15, wherein the instructions that when executed by the one or more processors further cause the one or more processors to retrieve emergency contacts from a user device associated with a user of the self-defense device.
